(19) United States
(12) Patent Application Publication
(10) Pub. No.: US 2025/0139417 A1
(43) Pub. Date: May 1, 2025

(54) WORKFLOW ASSISTANT WITH GENERATIVE ARTIFICIAL INTELLIGENCE

(71) Applicant: Intuit, Inc., Mountain View, CA (US)

(72) Inventors: Shyamalendu Tripathy, Bangalore (IN); Bidisha Mondal, Bangalore (IN); Bhavishya Tolani, Bangalore (IN); Yash Agarwal, Bangalore (IN); Mahamed Zubair Bake, Bangalore (IN)

(21) Appl. No.: 18/495,172

(22) Filed: Oct. 26, 2023

(51) Int. Cl. G06N 3/047

(52) U.S. Cl. CPC G06N 3/047

(57) ABSTRACT

Certain aspects of the disclosure pertain to workflow creation assistance with generative artificial intelligence. A problem statement can be received that is specified by a user in a natural language. At least one machine learning model can infer a workflow template that maps to the problem statement. Workflow template parameters can be determined, and parameter values generated based on the problem statement. Additional interaction with the user in the natural language can be performed to request and receive further data associated with the workflow template with the at least one machine-learning model. Subsequently, the workflow template can be populated with generated parameter values and provided to a workflow system that generates a workflow based on the workflow template.

### BACKGROUND

### Field

Aspects described herein relate to automated workflow assistance with generative artificial intelligence.

### Description of Related Art

Workflows can be specified in a workflow system to automate tasks. In the context of financial management, tasks can include generating new invoices, sending payment reminders to customers, and sending reminders to a team to complete specific tasks such as reviewing open invoices. Generally, a workflow can be specified in terms of conditions and actions. Conditions can specify a trigger that activates a workflow. After activation, actions specified in the workflow can be performed. Specifying a workflow from scratch typically requires specialized knowledge and is technically complicated. A workflow system can provide templates to mitigate the burden of workflow creation from scratch, but templates do not eliminate the burden. Further, given a particular problem, it may be unclear which workflow and template are appropriate to address the problem. Accordingly, there is a need in the art for an improved workflow generation mechanism.

### SUMMARY

According to one aspect, a method of workflow generation includes receiving a problem statement specified by a user in a natural language, inferring a workflow template that maps to the problem statement by at least one machine learning model, interacting with the user in the natural language to request and receive data associated with the workflow template by the at least one machine learning model, populating the workflow template with the received data by the at least one machine learning model, and triggering generation of the workflow with a workflow system based on the workflow template.

Other aspects provide processing systems configured to perform the aforementioned method as well as those described herein; non-transitory, computer-readable media comprising instructions that, when executed by a processor of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects of this disclosure.

### DESCRIPTION OF THE DRAWINGS

The appended figures depict certain aspects and are, therefore, not to be considered limiting of the scope of this disclosure.

FIG. 1 is a block diagram of a high-level overview of an example implementation of improved workflow generation.

FIG. 2 is a block diagram of an example workflow assistant system.

FIG. 3 is a block diagram of an example workflow generation architecture.

FIG. 4 is a flow chart diagram of an example method of workflow assistance.

FIG. 5 is a flow chart diagram of an example method of template completion.

FIGS. 6-9 are example screenshots associated with workflow assistance.

FIG. 10 is a block diagram of an operating environment within which aspects of the subject disclosure can be performed.

To facilitate understanding, identical reference numerals have been used, where possible, to designate identical elements common to the drawings. It is contemplated that elements and features of one embodiment may be beneficially incorporated in other embodiments without further recitation.

### DETAILED DESCRIPTION

Aspects described herein provide apparatuses, methods, processing systems, and computer-readable mediums for automated workflow assistance. A workflow system is generally designed to automate and manage a flow of tasks, activities, and processes, for example, within an organization. The workflow system provides a centralized platform for defining, executing, and monitoring processes to reduce errors and enhance productivity. Some workflow systems utilize templates, a pre-defined framework or structure that provides a starting point for creating customized workflows. Templates provide a foundation for generating new workflows to expedite creation and reduce the learning curve for new users.

A technical problem exists with workflow systems in that such systems require specialized knowledge and technical skill to create workflows, thereby limiting the use of workflows and increasing the likelihood of errors and process inefficiency. Employment of templates can reduce, but does not eliminate, this burden. Further, templates can introduce other problems in that it may be unclear to a user which, if any, workflow and template are appropriate to address a problem. For example, a user may have customers who are not paying on time, but the user may not know about the concept of workflows or that this problem can be solved by creating an invoice overdue reminder workflow, much less how to implement the workflow with or without templates.

Aspects described herein provide a technical solution to at least the aforementioned technical problem by substantially reducing or eliminating the specialized knowledge and technical skill required to generate a workflow. A workflow assistant is disclosed that employs generative artificial intelligence to create workflows within a workflow system or service. The workflow assistant enables a user to specify a problem in a natural language. Using one or more machine learning models, a workflow template that addresses the problem can be determined, template parameters can be fetched, and values of the parameters can be generated based on input and interaction with the user, among other things. Subsequently, a completed workflow template can be employed to generate a workflow automatically. Consequently, the workflow assistant enables more workflows to be developed and employed, reducing errors and improving the efficiency and processes of underlying applications (e.g., project management, finance) that employ workflow systems.

### Example Implementation of a Workflow Assistant System

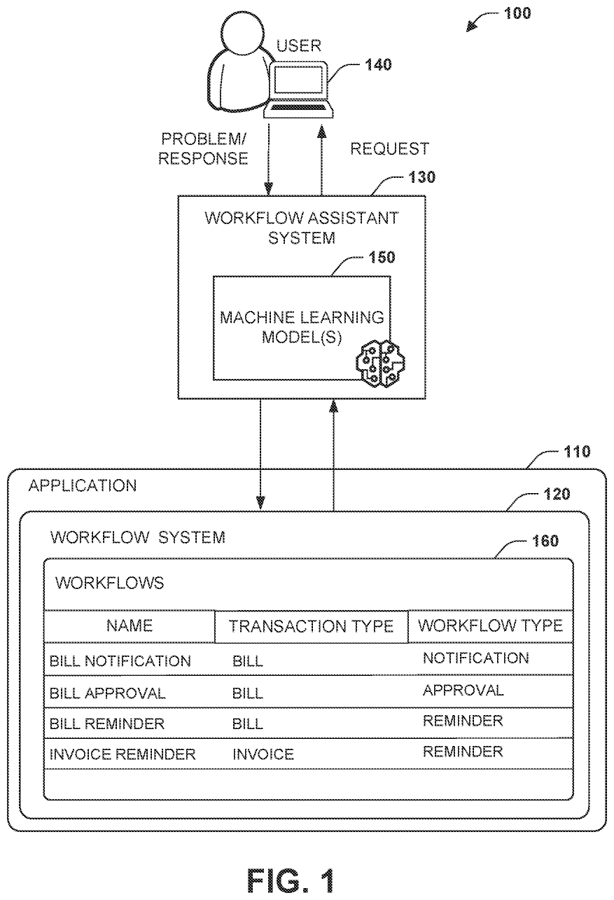

FIG. 1 depicts a high-level overview of an example implementation 100 of aspects associated with improved workflow generation. The implementation includes an application 110 comprising a workflow system 120 and a workflow assistant system 130.

The application 110 can be substantially any software application or set of applications including, but not limited to, project management software or a financial management application. Moreover, the application can include or interact with a workflow system 120. The workflow system 120 enables automation and optimization of tasks, processes, or activities including creation and execution of workflows. In other words, a workflow can comprise an orchestrated and repeatable pattern of activities and provide a way to automate tasks. In a financial management application domain, workflows can automate tasks such as processing recurring invoices, sending reminders for overdue payments, categorizing and tracking expenses, and generating financial reports, among other things. In one embodiment, the workflow system 120 can include a set of templates that facilitate creating a workflow by specifying template parameters that can then be used to generate a workflow.

The workflow assistant system 130 is communicatively coupled with the workflow system 160 (or workflow engine) through the application 110. Although the workflow assistant system 130 is shown as separate from the workflow system 120 and the application 110, in alternate embodiments, the workflow assistant system 130 can be integrated within the application 110 or workflow system 120. In one embodiment, the workflow assistant system 130 can be implemented as a plugin that extends the functionality of a workflow system 120 implemented as a service. The workflow assistant system 130 can also be communicatively coupled to a user by way of a user computing device 140 (e.g., tablet, desktop computer, terminal, laptop computer, smartphone, etc.). The workflow assistant system 130 can thus be an intermediary between a user computing device 140 and the workflow system 120.

Furthermore, the workflow assistant system 130 can include or interact with one or more machine learning models 150, including deep learning models, or the like trained to facilitate interaction by a user with the workflow system 120 to enable easy, efficient, and automatic workflow generation. In one embodiment, an intelligent virtual assistant or chatbot can receive a text problem statement from a user and invoke a generative pre-trained transformer (e.g., GPT-4) to determine and create an appropriate workflow for the user. In one instance, the workflow assistant system 130 can transform a problem into prompts for a generative pre-trained transformer to aid in identifying a corresponding template and generating data to complete the template. Additionally, or alternatively, a neural logic machine can be employed, which is a type of machine learning model that combines neural networks with symbolic reasoning. The neural logic machine can use inductive and logical reasoning to learn relationships between problem statements and workflows and utilize the learned relationships to make predictions.

In accordance with one aspect, a user, by way of the user computing device 140, can specify a problem statement somewhat abstractly in a natural language. For example, a user can say, “I am having trouble with bills being paid on time.” The workflow assistant system 130 can utilize a machine learning model 150 trained to recognize the natural problem statement, for example, utilizing natural language processing, and identify a workflow template corresponding to the problem statement, such as a bill reminder workflow template. The same or a different machine learning model 150 can initiate generation of the workflow template by mapping data in the problem statement to template parameters and requesting missing template values.

The machine learning model 150 can produce a score, such as a confidence score, associated with categorization and content generation predictions. In one instance, the score can express a degree of confidence that the workflow template matches or addresses the problem statement, for example, based on template metadata, parameters, or both. The confidence score can aim to utilize a function that produces a numerical score that quantifies relatedness between the problem statement and the workflow template. In another instance, the score can indicate a level of certainty associated with the accuracy, relevance, and trustworthiness of generated content. In other words, the score can represent the confidence in the quality and appropriateness of output produced by a generative system.

In accordance with one embodiment, the score can be calculated using least squares criteria for best fit. In the context of computing a similarity score, least of squares criteria can be applied to measure the similarity or dissimilarity between two sets of data or vectors. Of course, the subject disclosure is not limited to this approach to computing similarity. Other approaches can be employed including but not limited to cosine similarity, Euclidean distance, and word embeddings.

Scores can be utilized in conjunction with thresholds to control processing. In one embodiment, if a score satisfies a threshold, the same or different machine learning model 150 can request additional data required to complete the workflow template parameters from the user, if needed. Template parameters capture template context, and parameter values can be identified automatically based on user-provided data. Subsequently, the workflow system 120 can generate a workflow based on a completed template. In one instance, the machine learning model 150 can converse with the user in natural language to clarify the problem statement by requesting additional information until the confidence score satisfies the threshold. Additionally, or alternatively, the workflow assistant system 130 can output the template partially completed as a suggestion. In this manner, a user can verify and optionally add or change the information in the template before triggering the generation of a corresponding workflow. Alternatively, the workflow can be generated but in an inactive or unenabled state, allowing a user to review the workflow and make changes before workflow execution.

The workflow system 120 can generate workflows 160. The workflows 160 can have, for example, a name, transaction type, and workflow type. Four example workflows are shown: bill notification, bill approval, bill reminder, and invoice reminder. The invoice reminder can remind a seller to generate an invoice or bill for a product or service. Bill approval can request approval of a bill by a seller, bill notification can notify a buyer of a bill from a seller, and bill reminder can send a reminder or an outstanding bill to a buyer. These workflows can also be associated with triggers or conditions, such as sending a bill reminder to purchasers with a past-due bill.

Moreover, the workflows can be generated from templates that are automatically generated based on a natural language description of a problem. Continuing with the previous example, a user can state that they are having trouble with bills being paid on time. The workflow assistant system 130 can utilize natural language processing to determine a problem statement and match a bill reminder template to the problem statement. The workflow assistant system 130 can also request additional information to aid in completing the bill reminder template. For example, the work assistant system 130 can request information about a potential type of buyer (e.g., individual, corporate, amount of sale), as well as when and how often to remind a buyer.

### Example System of Workflow Assistance

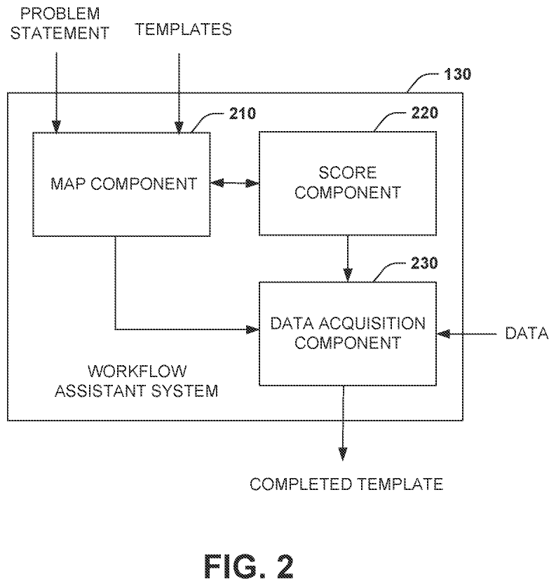

FIG. 2 illustrates a block diagram of an example implementation of the workflow assistant system 130 briefly described in FIG. 1. In the depicted example, the workflow assistant system 130 includes map component 210, score component 220, data acquisition component 230, and entity identification component 240. The map component 210, score component 220, and data acquisition component 230 can be implemented by at least one processor coupled to at least one memory that stores instructions that, when executed by the at least one processor, cause the processor to perform the functionality of each component when executed. Furthermore, all or a portion of the functionality of each component can be performed alone, in conjunction with, or by the machine learning models 150 of FIG. 1 (e.g., artificial neural network, generative pre-trained transformer). Consequently, a computing device can be configured to be a special-purpose device or appliance that implements the functionality of the workflow assistant system 130. Further, all or portions of the workflow assistant system 130 can be distributed across computing devices or made accessible through a network service. Furthermore, all portions of the workflow assistant system 130 can be implemented in a plugin for the workflow system 120 and can interact with machine learning models or other generative artificial intelligence technology to create workflows in accordance with one embodiment.

The map component 210 is configured to receive a statement or question, such as a problem statement, from a user in natural language text or audio. The map component 210 can be configured to classify the problem statement into one or more known or learned classifications, categories, or types. For example, a user can state, “I forget to send invoices on time” or “Send my high-valued bills for review.” Subsequently, the map component 210 can link an input problem statement in a natural language to a template from a set of templates that addresses the problem statement. In the example, “I forget to send invoices on time” can be mapped to an invoice unsent reminder workflow template, and “Send my high-valued bills for review” can be mapped to a bill approval workflow template. In one instance, the map component 210 can retrieve template data or metadata from a template repository of the workflow system 120 and map the statement to a similar template based on the template data. In another instance, a machine learning model 150 can learn mappings through training data in a supervised learning scenario. In accordance with one embodiment, a machine learning model 150 can output the top matching template and confidence score that captures the likelihood that the template matches the problem statement. Alternatively, a top “x” number of matches can be output. The confidence score can be returned based on a similarity technique that matches the statement to a template (e.g., least of squares).

The score component 220 is configured to evaluate the confidence score associated with a matching template and a problem statement. The score component 220 can include at least one threshold. The threshold can be a value configured to control subsequent processing. For example, if the confidence score satisfies a threshold, further processing can be performed to complete the template. If the confidence score of a template fails to satisfy the threshold or satisfies a different threshold, then the template may be rejected. In one embodiment, the score component 220 can notify the map component 210, which can request further information from a user regarding the problem statement to aid in identifying a template with a higher confidence score. In an alternative embodiment, the workflow assistant system 130 can output one or more templates as a suggestion, which a user can select and complete. In addition to capturing how well a default template matches a problem statement, the confidence score or a different score can also capture a confidence level associated with the generated content, which refers to the degree of reliability associated with the accuracy, relevance, and trustworthiness of the generated content. Comparison of this score to a threshold can control processing as to when a workflow is created and enabled rather than requesting more information for a user or providing a template prefilled with values as a suggestion to the user.

The data acquisition component 230 is configured to acquire and complete a template with corresponding data. The data acquisition component 230 can receive or retrieve a template that maps to a problem statement from the map component 210. The score component 220 can provide a score or other signal associated with the template. The score or other signal can prompt the data acquisition component 230 to acquire data for the template. Required data can be identified from the template or metadata regarding the template. For example, in the previous example, where a problem statement related to providing high-valued bills for review that mapped to a bill approval workflow, more information about what qualifies as a high-valued bill may need to be acquired. In accordance with one embodiment, the data acquisition component 230 can request data from a user. For example, generative artificial intelligence techniques, such as those associated with virtual intelligent agents or chatbots, can be utilized to request data in the user's natural language. Furthermore, the request can be conversational rather than a formal and impersonal request for the data. Such requests can be termed prompt engineering. Template parameters or attributes that may need to be provided include, but are not limited to, conditions or triggers, task assignment, when and how notifications or alerts are sent, and the content or format of notifications. Once data is acquired, a template can be opened and dynamically populated with the data. The workflow system 120 (of FIG. 1) can subsequently utilize the template to generate a corresponding workflow automatically.

In accordance with one embodiment, a user can interact with a workflow assistant implemented as a workflow plugin. The workflow plugin can pass the context and additional details to a generative artificial intelligence model. The model can subsequently fetch a workflow domain as context and input to the model. For example, data regarding one or more templates can be acquired from a template repository or store. The model can output parameters such as but not limited to transaction types (e.g., invoice, bill, estimate, purchase order), status (e.g., paid, unpaid, overdue, unsent), condition parameter (e.g., transaction amount, transaction balance amount, transaction send status), condition value (e.g., 1000, Bangalore), condition data type (e.g., days, numeric, string), conditional operator (e.g., greater than, greater than or equal to, equals, less than, less than or equal to, contains, does not contain, saved, updated, before, or after), workflow action type (e.g., reminder, notification, approval), a request for additional information if needed (e.g., when conditional values are not present or the assigned user is not present), and a score. The score can represent the confidence level of the aforementioned parameters and can be calculated utilizing least squares criteria for best fit. In one particular instance, parameters needed to build context can be retrieved, tuned, and built as a vector that can be passed to a model (e.g., chat GPT) to fetch a response and a score. Actions can be taken based on the value of the score. For example, if the score equals 100, the workflow can be built and enabled. If the confidence score equals 50, the workflow can be built but in a disabled state (e.g., not enabled/inactive). If the score is less than 5 and additional information is needed, the user can be prompted for the additional information. If the score is less than 5 and additional information is unnecessary, the workflow template page can be opened with current information, allowing the rest to be prefilled by a user. This approach uses generative artificial intelligence to recommend and build a workflow for a user (e.g., customer). However, generative artificial intelligence can refer to any artificial intelligence or machine learning model capable of generating content. Accordingly, other approaches are also possible that produce similar results, such as using a large language model (LLM) tuned to generate workflows based on tokenized input of a user.

### Example Workflow Generation Architecture

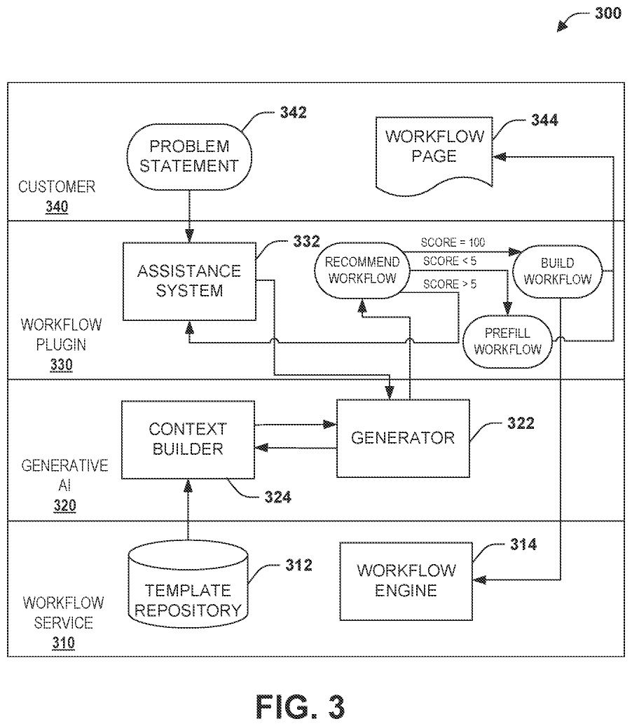

FIG. 3 is an example workflow generation architecture 300 in accordance with one embodiment. The workflow generation architecture 300 includes four layers: workflow service layer 310, generative artificial intelligence (AI) layer 320, workflow plugin layer 330, and customer layer 340. The workflow service layer 310 corresponds to the workflow system 120 of FIG. 1 and includes template repository 312 and workflow engine 314. The template repository 312 is a non-volatile store that includes workflow templates and metadata regarding templates. The workflow engine 314 is configured to generate a workflow automatically based on a template with specified parameters. The generative AI layer 320 can correspond to the machine learning model(s) 150 of FIG. 1, as generative AI employs machine learning models and, more specifically, deep learning models to generate content or data in the form of text, among other things. The generative AI layer 320 includes generator 322 configured to generate workflow template data, and context builder 324 configured to acquire template data as context to aid generation. The workflow plugin layer 330 is configured to extend the functionality of the workflow service layer 310 by adding additional features including integration of the generative AI layer 320. The workflow plugin layer 330 includes assistance system 332, which corresponds to the workflow assistant system 130 of FIG. 1, and is configured to converse with a user in natural language to receive a problem statement and identify workflows, and corresponding templates, that address the problem statement. The customer layer 340 can correspond to the application 110 of FIG. 1, enabling a user to specify a problem statement 342 and receive a workflow page 344 in response. The workflow page 344 can include a graphical user interface that displays filled or partially completed template parameters and enables parameter editing.

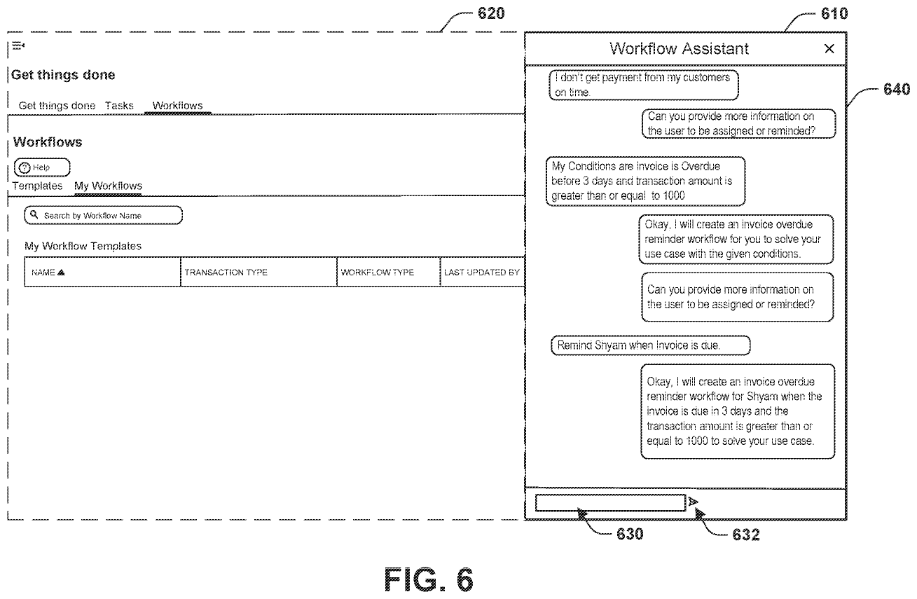

As an example, a user can specify a problem statement 342 by way of the customer layer 340, which is received by the assistance system 332 of the workflow plugin layer 330. The assistance system 332 can identify a template associated with a workflow that addresses the problem statement 342. The assistance system 332 initiates generation of the workflow template by invoking the generator 322 of the generative AI layer 320 with a built prompt. The generator 322 can then invoke the context builder to determine template parameters to be generated. The context builder can retrieve such context from the template repository 312 in the workflow service layer 310. For instance, the context builder 324 can utilize a query language (e.g., graphQL) to read template data from the template repository. In one embodiment, a REST API can be utilized to fetch parameters needed to build the context. The generator 322 can generate parameter values such as transaction type, status, condition, condition value, condition, type, workflow action type, and score. The generator 322 can return a workflow template and a score associated with the template. The score can represent a confidence level associated with the generated parameter values. Stated differently, the confidence level can refer to the degree of reliability associated with the accuracy, relevance, and trustworthiness of generated content. In one instance, the score can be calculated using least squares criteria for best fit. In accordance with one embodiment, the parameters can be specified and built into a vector that is passed to Chat GPT to fetch a response and score. The score can be analyzed and subsequent action controlled based on the score. For instance, if the score is equal to one hundred, indicating a high degree of confidence in the generated content, a workflow can be generated by submitting the template to the workflow engine 314 in the workflow service layer 310 and subsequently enabling the workflow. If the score equals fifty, the workflow could be generated by sending the template to the workflow engine 314 but not automatically enabled. If the score is less than five, indicating very low confidence in the generated content, the workflow template can be prefilled, but the workflow is not generated or enabled. If the score is greater than five but less than fifty, additional details are needed to improve the confidence in the generated content. Accordingly, the assistant system 332 can be prompted to request additional details from a user. The output of the workflow plugin layer 330 and the input of the customer layer 340 can be the workflow page 344, which includes details associated with a workflow and workflow template as generated for review and potential editing by the user. An example of the workflow page 344 is provided later with respect to the example screenshots of FIGS. 6-9.

### Example Methods of Workflow Assistance

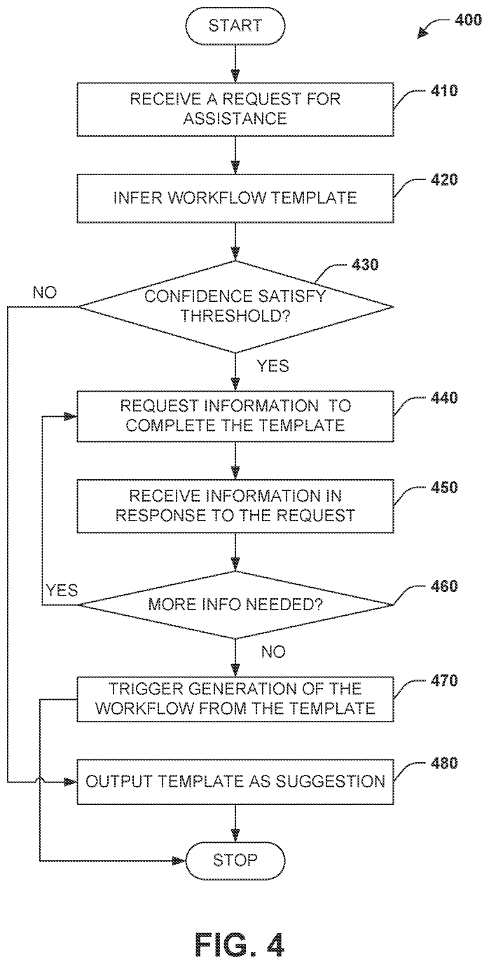

FIG. 4 depicts an example method 400 of workflow assistance. In one aspect, method 400 can be implemented by the workflow assistant system 130 of FIG. 1.

Method 400 starts at block 410 with receiving a request for assistance. A user can request assistance with a computing device through an application. For example, a user could ask a question or state a problem the user is dealing with in natural language text or voice that is received by the workflow assistant system 130. In one embodiment, a conversational chatbot or virtual intelligent assistance can be employed to receive the request as well as request and receive further information.

Method 400 then proceeds to block 420, inferring a workflow template associated with a received question or problem statement. One or more machine learning models 150 can be executed to infer, predict, or otherwise determine a workflow template matching the problem statement. In one embodiment, one or more machine learning models 150 can be trained to identify the problem statement utilizing natural language processing to classify the problem statement based on historical data. Further, the same or a different machine learning model 150 can use learned mappings between problem statements or classes of problem statements and workflow templates as a basis for inferring a match. The machine learning model 150 can also assign a score, such as a confidence score, identifying the likelihood that a workflow template matches a problem statement or class.

Method 400 continues next to block 430, where a decision is made regarding whether or not a confidence score satisfies a threshold. A threshold establishes a limit or bound on a confidence score that can control further processing. For example, a threshold can correspond to a minimum or maximum confidence score. If the confidence score satisfies the threshold (“YES”), then the method 400 can proceed to block 440. Alternatively, if the confidence score fails to satisfy the threshold (“NO”) or satisfies a different threshold, then the method 400 can continue to block 480.

The method 400 proceeds to block 440 when the confidence score satisfies a threshold at block 430. At block 440, information or data associated with an inferred workflow template is requested. For example, interaction with a user through natural language text or audio can continue through the same communication medium used to request assistance at block 410 (e.g., intelligent virtual assistant, chatbot). The information or data can be template-dependent, such that different data can be requested for first and second templates. Further, the information or data can be referred to as template parameters or attributes, including conditions, triggers, and actions, among other things.

The method 400 continues to block 450, where information or data is received in response to the request. The data can relate to one or more conditions associated with triggering a workflow, one or more actions performed in response to a trigger, task assignments, notification information, and when the workflow terminates, among other things.

The method 400 proceeds to block 460, where a determination is made as to whether or not more information is needed to complete a workflow template. If more information is needed (“YES”), then the method returns to block 440, where information is requested. If more information is unneeded (“NO”), the method 400 advances to block 470.

At block 470, workflow generation is triggered based on a populated template. For example, the completed template can be provided to the workflow system 120 (of FIG. 1), which is configured to generate a workflow automatically from a template.

Alternatively, the method 400 at block 480 can continue where a template is output as a suggestion. In this scenario, a minimum confidence threshold may not have been met at block 430, and rather than continuing to generate a workflow that may not be desired, a template or set of templates can be output as suggestions to the user, who can then select an appropriate template for manual or automatic completion.

In one embodiment, the method 400 can seek to generate content for template parameters based solely on the request for assistance, such as a problem statement. For example, content can be predicted for parameters, and a score associated with the confidence of the generated content can be returned. This score can be compared to one or more thresholds to determine whether or not to request additional information or return the template as a suggestion, among other things. A confidence score can be high when a significant amount of information is provided in the request for assistance. However, if the request for assistance is terse, the confidence score can be low, and further detail may need to be requested and received from a user.

Note that FIG. 4 is just one example of a method, and other methods including fewer, additional, or alternative steps are possible consistent with this disclosure.

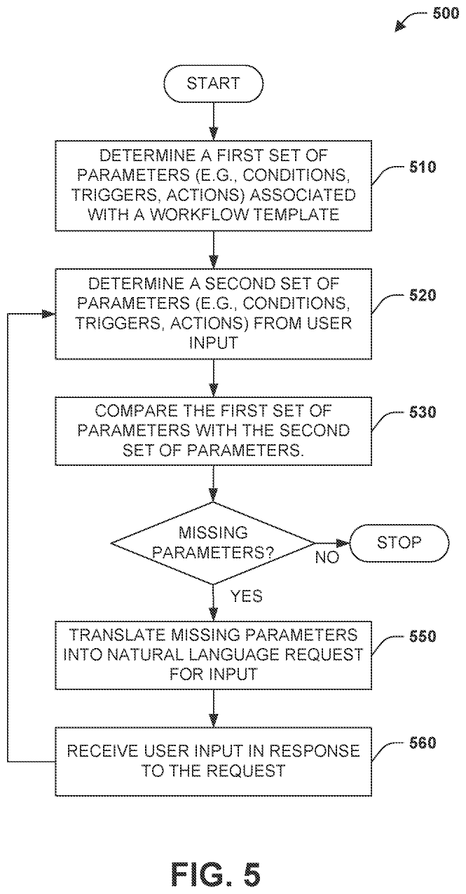

FIG. 5 depicts an example method 500 of automatic template completion associated with workflow assistance. In one aspect, method 500 can be implemented by the workflow assistant system 130 (of FIG. 1), including user interaction associated with acquiring data from a user and completing a template or, in other words, prompt engineering.

Method 500 starts at block 510 with determining a first set of parameters or attributes associated with a workflow template. In accordance with one aspect, the workflow template can be selected as a match for a user problem statement. Parameters can be determined by analyzing a template or metadata associated with the template. A parameter can be a placeholder or variable in a template that is assigned a specific value or content. In accordance with one embodiment, the template parameters can be fetched from a repository or the workflow system 130. The parameters can be workflow-dependent but generally correspond to conditions, triggers, actions, and other details. For example, for a bill reminder, conditions that define a trigger can correspond to the value of the bill, and action can correspond to sending a customer email. Other parameters can correspond to whom a task is assigned and when to close the task, among other things.

The method 500 continues at block 520 by determining a second set of parameters from user input. For example, a problem statement can be analyzed for context information corresponding to one or more conditions, actions, or triggers. A condition can be an expression, such as “TxnAmount>1000.” Here, the expression includes a variable (e.g., transaction amount), an operator (e.g., greater than, less, than, equal), and a value (e.g., 1000). An action can correspond to approval, reminder, or notification, among other things. Further, the action can have an assignee to whom the action is assigned. For example, the assignee can be an individual to whom a reminder is sent. An action can specify a step or task to perform, such as emailing a customer or generating a mobile notification, among other things. A trigger is an event that initiates the performance of a corresponding action. One or more conditions can define when a trigger occurs, such as when an invoice is due in a predetermined number of days. The one or more conditions, actions, or triggers, among other things, can correspond to the second set of attributes.

The method continues at block 530 by comparing the first set of parameters from user input and the second set of parameters from a workflow template. A result of the comparison can be zero or more parameters missing from the first set of parameters with respect to the second set of parameters. Stated differently, the comparison enables the identification of template parameters without data to populate the parameters.

The method 500 proceeds at block 540 to determine whether there are any missing parameters. The method can successfully terminate if there are no missing parameters (“NO”). If there are missing parameters (“YES”), then further processing can be performed.

The method 500 continues at block 550, translating missing parameters into a natural language. In other words, the missing parameters can be translated into a natural language request for particular data and sent to the user.

The method 500 continues at block 560 by receiving user input in response to the request. The method can subsequently loop back to block 520, where one or more parameters or other details are identified from the user input.

By way of example, consider a problem statement, such as “Provide my high-valued bills for review,” that maps to a bill review template. The bill review template or metadata surrounding the bill review template can be analyzed to determine parameters specific to the bill review template at block 510. In one embodiment, the determination can involve fetching the parameters for a workflow template from the workflow system 130 (of FIG. 1). For instance, one parameter can be the identity of the person assigned the workflow (e.g., assignee), and another parameter can be a name of the bill for review or a set of one or more conditions that define a bill or bills for review. The second set of parameters or parameter values can be determined from user input at block 520, which can first correspond to the problem statement. The name of the person specifying the problem can be determined from the user name or other means associated with the problem statement at block 520. The first and second sets of parameters can be compared at block 530. The determination at block 540 can indicate missing parameters, such as bill identification. At block 550, a request can be generated to request bill identification. However, the request can be specified in natural language based on context data. For example, the request can ask, “What do you consider high-valued bills?” Input can be received at block 560 in response to the request. Subsequently, the response can be analyzed to determine one or more parameters at block 520. The method 500 can continue until there are no missing parameters.

Method 500 pertains to acquiring substantially all information required to complete a workflow for the user input. Some information can be acquired directly from a user. Other information can be inferred by a machine learning model based on context associated with the user input and other available information regarding the user (e.g., business, preferences, standard business practices). It is further to be appreciated that various default information or details can also be prefilled but can be updated by a user, such as the content and format of notifications, among other things. In this manner, user requests can be limited to what is needed, such as what clients the user considers high-value clients for bill review and processing.

Note that FIG. 5 is just one example of a method, and other methods including fewer, additional, or alternative steps are possible consistent with this disclosure.

### Example Workflow Assistance User Interface and Experience

FIGS. 6-9 depict example screenshots associated with workflow assistance. The example screenshots illustrate how a user can interact with the workflow assistant system 130, the application 110, and workflow system 120 of FIG. 1 through a graphical user interface. Further, the screenshots can illustrate aspects of the workflow page 344 of FIG. 3 in accordance with certain embodiments. Aspects of the disclosed subject matter are not limited to the user interfaces and experience associated with the example screenshot in FIGS. 6-9. It is possible and contemplated that the screenshots can include different graphical elements, positions of graphical elements, and interactive sequences, among other things.

FIG. 6 illustrates an example screenshot enabling automatic generation of workflow templates. The screenshot shows an interface window comprising two panes: a workflow assistant pane 610 and a workflow system pane 620. The workflow assistant pane 610 is spawned in conjunction with a workflow system 120 of an application 110. Here, the workflow assistant pane 610 is active, as indicated by solid lines, while the workflow system pane 620 is inactive, as shown by dashed lines. The workflow assistant pane 610 enables natural language communication between a user and the workflow assistant system 130. More specifically, the workflow assistant pane 610 corresponds to a chat user interface. The workflow assistant pane 610 includes an input field 630 that enables users to type messages and a send icon 632 to send the message. Further, the workflow assistant pane 610 includes message bubbles 640 that capture the messages between a user and the workflow assistant system 130. In this particular example, the message bubbles capture a user entering a problem statement: “I don't get payment from my customer.” On the backend, it can be determined by the workflow assistant system 130 that this problem statement corresponds to a reminder template, and information associated with a reminder template can be requested, such as “Can you provide more information on the user to be assigned or reminder?” The user can subsequently enter “My Conditions are Invoice is Overdue before 3 days and transaction is greater than or equal to 1000.” The system responds, “Okay, I will create an invoice overdue reminder workflow for you to solve your use case with the given conditions.” Since the user was not responsive to a request for the user to be assigned or reminded, the request can be made again. In response, the user can state, “Remind Shyam when the invoice is due,” and the system can respond, “Okay, I will create an invoice overdue reminder for Shyam when the invoice is due in 3 days and the transaction amount is greater than or equal to 1000 to solve your use case.”

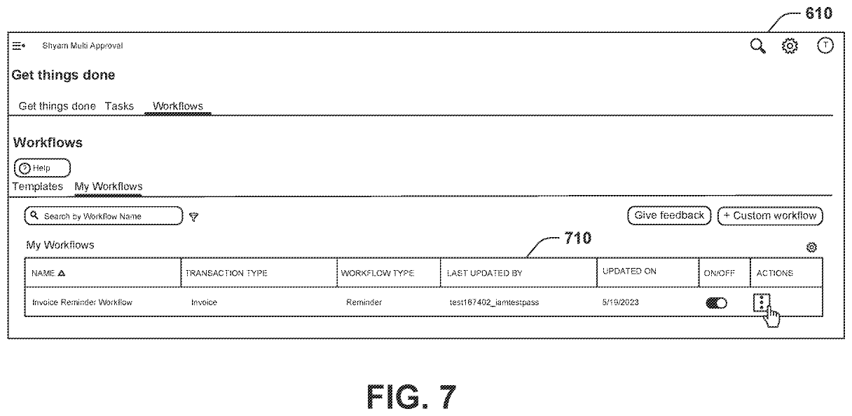

FIG. 7 is a screenshot of the workflow system pane 620. The workflow system pane 620 is now active without the workflow assistant pane 610 and is updated given the conversation described above with respect to the workflow assistant pane 510 of FIG. 5. More specifically, the workflow table 710 is updated to include the workflow that was automatically generated based on the natural language conversation in the workflow assistance pane 510 of FIG. 5. The workflow table has columns that correspond to name, transaction type, workflow type, last updated by, updated on, on/off, and actions. The row includes information about the automatically generated workflow. The workflow name is “Invoice Reminder Workflow,” the transaction type is “Invoice,” and the workflow type is “Reminder.” Further, the workflow was last updated by a user identified as “test167402_iamtestpass” on May 19, 2023. The workflow is set to “ON” rather than “OFF,” indicating that the workflow is currently active and able to be triggered based on specified conditions. Finally, the actions column is an icon that, when activated or selected, allows further inspection and editing of details regarding the workflow.

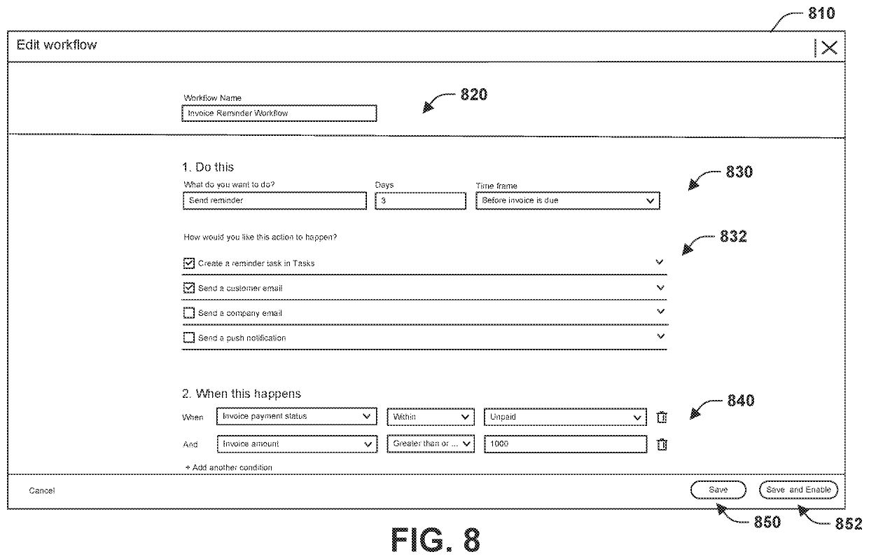

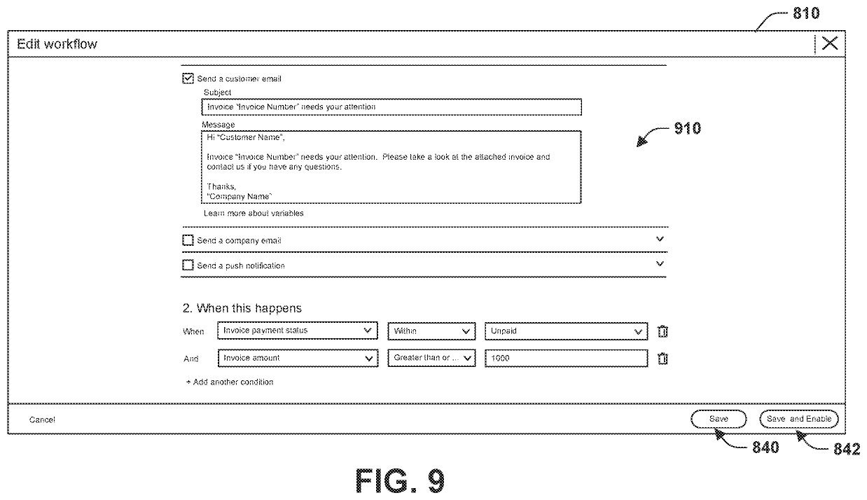

FIG. 8 is a screenshot of an edit workflow interface window 810 that can be displayed when the actions icon is selected in the workflow system pane 520 of FIG. 7. The interface window 810 includes the workflow name “Invoice Reminder Workflow” in a text box at 820, identifying a subject workflow for viewing and optionally editing. Below the workflow name text box is a “Do This” section at 830 that specifies what the workflow is to do or, in other words, what action is performed by the workflow. In this instance, a reminder is to be sent three days before an invoice is due. How the action is performed can be specified through check boxes at 832. As shown, create a reminder in tasks and send a customer email are checked, while send a company email and send a push notification are unchecked. In addition to checking or unchecking a box, actions can be expanded to include further detail, as described below in FIG. 9. Conditions defining a trigger can be provided at 840 entitled “When this happens.” The conditions include when invoice status is unpaid, and the invoice amount is greater than or equal to 1000. Edits to workflow can be saved without enabling the workflow by selecting a first button at 850. A workflow can be saved and enabled by activating a second button at 852. Enabling the workflow initiates execution of the workflow, while saving without enabling saves the workflow but does not initiate execution of the workflow.

FIG. 9 is a screenshot of the edit workflow interface window 810 of FIG. 8 with the send a customer email section expanded at 910. In this instance, the email subject and messages are displayed and available for editing if desired. Further, the email includes variables that will be assigned corresponding values. The variable “Invoice Number” can be assigned a value associated with an invoice for which an amount is greater than one thousand, and the status is unpaid. The variable “Customer Name” can be assigned a customer name associated with the invoice number. Although not shown, other actions, such as send a company email and send a push notification, can be expanded for display and optional editing.

### Example Processing System for Workflow Assistance

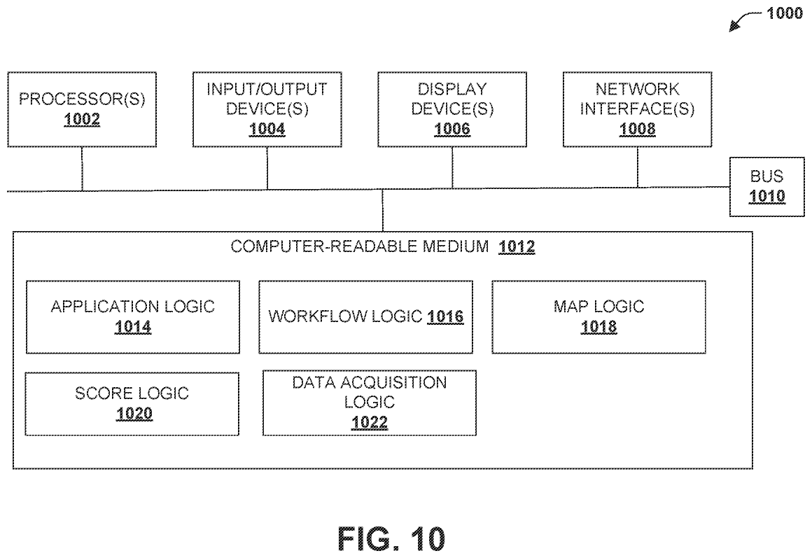

FIG. 10 depicts an example processing system 1000 configured to perform various aspects described herein, including, for example, methods as described above with respect to FIG. 4 and FIG. 5.

Processing system 1000 is generally an example of an electronic device configured to execute computer-executable instructions, such as those derived from compiled or interpreted computer code, including without limitation personal computers, tablet computers, servers, smart phones, smart devices, wearable devices, augmented or virtual reality devices, and others.

In the depicted example, processing system 1000 includes one or more processors 1002, one or more input/output devices 1004, one or more display devices 1006, and one or more network interfaces 1008 through which processing system 1000 is connected to one or more networks (e.g., a local network, an intranet, the Internet, or any other group of processing systems communicatively connected to each other), and computer-readable medium 1012.

In the depicted example, the aforementioned components are coupled by a bus 1010, which may generally be configured for data or power exchange amongst the components. Bus 1010 may be representative of multiple buses, while only one is depicted for simplicity.

Processor(s) 1002 are generally configured to retrieve and execute instructions stored in one or more memories, including local memories like the computer-readable medium 1012, as well as remote memories and data stores. Similarly, processor(s) 1002 are configured to retrieve and store application data residing in local memories like the computer-readable medium 1012, as well as remote memories and data stores. More generally, bus 1010 is configured to transmit programming instructions and application data among the processor(s) 1002, display device(s) 1006, network interface(s) 1008, and computer-readable medium 1012. In certain embodiments, processor(s) 1002 are included to be representative of one or more central processing units (CPUs), graphics processing units (GPUs), tensor processing units (TPUs), accelerators, and other processing devices.

Input/output device(s) 1004 may include any device, mechanism, system, interactive display, or various other hardware components for communicating information between processing system 1000 and a user of processing system 1000. For example, input/output device(s) 1004 may include input hardware, such as a keyboard, touch screen, button, microphone, or other device for receiving inputs from the user. Input/output device(s) 1004 may further include display hardware, such as, for example, a monitor, a video card, or other device for sending or presenting visual data to the user. In certain embodiments, input/output device(s) 1004 is or includes a graphical user interface.

Display device(s) 1006 may generally include any device configured to display data, information, graphics, user interface elements, and the like to a user. For example, display device(s) 1006 may include internal and external displays, such as an internal display of a tablet computer or an external display for a server computer or a projector. Display device(s) 1006 may further include displays for devices, such as augmented, virtual, or extended reality devices.

Network interface(s) 1008 provide processing system 1000 access to external networks and processing systems. Network interface(s) 1008 can generally be any device capable of transmitting or receiving data through a wired or wireless network connection. Accordingly, network interface(s) 1008 can include a transceiver for sending or receiving wired or wireless communication. For example, Network interface(s) 1008 may include an antenna, a modem, a LAN port, a Wi-Fi card, a WiMAX card, cellular communications hardware, near-field communication (NFC) hardware, satellite communication hardware, or any wired or wireless hardware for communicating with other networks or devices/systems. In certain embodiments, network interface(s) 1008 includes hardware configured to operate in accordance with the Bluetooth® wireless communication protocol.

Computer-readable medium 1012 may be a volatile memory, such as a random access memory (RAM), or a non-volatile memory, such as non-volatile random access memory, phase change random access memory, or the like. In this example, computer-readable medium 1012 includes application logic 1014, workflow management logic 1016, map logic 1018, score logic 1020, and data acquisition logic 1022.

In certain embodiments, application logic 1014 can include software application functionality to perform specific tasks, functions, or processes on an electronic device including the processing system 1000. The application logic 1014 can correspond to a single computer program or a collection of programs for various purposes, such as financial and accounting applications and productivity applications, among others. The application 110 of FIG. 1 can perform the application logic 1014.

In certain embodiments, workflow logic 1014 can facilitate, automate, and streamline workflows. In one instance, the workflow logic 1014 can expose templates for specifying a workflow and utilize a template to generate the workflow automatically. The workflow logic 1014 can be performed by the workflow system 120 of FIG. 1.

In certain embodiments, map logic 1018 can map a natural language problem statement to a corresponding workflow template. The map component 210 of FIG. 2 can perform the map logic 1018.

In certain embodiments, score logic 1020 compares a confidence score associated with mapping a problem statement to a template to a threshold to control subsequent processing. The score component 220 of FIG. 2 can perform the score logic 1020.

In certain embodiments, data acquisition logic 1022 requests and receives data to complete a template and subsequently makes the completed template available for workflow generation. The data acquisition component 230 of FIG. 2 can perform the data acquisition logic 1022.

Note that FIG. 10 is just one example of a processing system consistent with aspects described herein, and other processing systems having additional, alternative, or fewer components are possible consistent with this disclosure.

### Example Clauses

Implementation examples are described in the following numbered clauses:
Clause 1: A method of generating a workflow, comprising receiving a problem statement specified by a user in a natural language, inferring a workflow template that maps to the problem statement by at least one machine learning model, receiving a parameter of the workflow template from a template repository, generating a value of the parameter of the workflow template by the at least one machine learning model based on the problem statement, and populating the workflow template with the value.
Clause 2: The method of Clause 1, further comprising receiving a score from the at least one machine learning model representing a confidence level of accuracy of the value, comparing the score to a threshold, and determining that the score satisfies the threshold.
Clause 3: The method of Clauses 1-2, further comprising triggering generation of the workflow with a workflow system based on the workflow template.
Clause 4: The method of Clauses 1-3, further comprising interacting with the user in the natural language to request and receive data associated with the workflow template by the at least one machine learning model.
Clause 5: The method of Clauses 1-4, further comprising determining context data from the problem statement, mapping the context data to a first set of one or more parameters, determining a second set of one or more parameters associated with the workflow template, and determining one or more missing parameters based on a comparison of the first set of one or more parameters and the second set of one or more parameters.
Clause 6: The method of Clauses 1-5, wherein determining the context data comprises determining at least one of a condition, trigger, or action.
Clause 7: The method of Clauses 1-6, wherein interacting with the user further comprises translating the one or more missing parameters into one or more natural language requests for data with the at least one machine learning model.
Clause 8: The method of Clauses 1-7, wherein one of the at least one machine learning model is a generative pre-trained transformer.
Clause 9: The method of Clauses 1-8, further comprising receiving the problem statement specified by the user through a conversational virtual agent linked with a software application including a workflow system.
Clause 10: The method of Clauses 1-9, wherein the software application is a financial management software application.
Clause 11: A method of workflow generation, comprising receiving a problem statement specified by a user in a natural language through a conversational virtual agent linked with a software application including a workflow system, inferring a workflow template that maps to the problem statement by at least one machine learning model, interacting with the user in the natural language through the conversational virtual agent to request and receive data associated with the workflow template by the at least one machine learning model, populating the workflow template with the data by the at least one machine learning model, and triggering generation of a workflow by the workflow system with the workflow template.
Clause 12: A processing system, comprising: a memory comprising computer-executable instructions and a processor configured to execute the computer-executable instructions and cause the processing system to perform a method in accordance with any one of Clauses 1-11.
Clause 13: A processing system, comprising means for performing a method in accordance with any one of Clauses 1-11.
Clause 14: A non-transitory computer-readable medium storing program code for causing a processing system to perform the steps of any one of Clauses 1-11.
Clause 15: A computer program product embodied on a computer-readable storage medium comprising code for performing a method in accordance with any one of Clauses 1-11.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from those described, and various steps may be added, omitted, or combined. Also, features described with respect to some examples may be combined in some other examples. For example, an apparatus may be implemented, or a method may be practiced using any number of the aspects set forth herein. In addition, the scope of the disclosure is intended to cover such an apparatus or method practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a−b, a−c, b−c, and a−b−c, as well as any combination with multiples of the same element (e.g., a−a, a−a−a, a−a−b, a−a−c, a−b−b, a−c−c, b−b, b−b−b, b−b−c, c−c, and c−c−c or any other ordering of a, b, and c).

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps or actions may be interchanged with one another without departing from the scope of the claims. In other words, unless a specific order of steps or actions is specified, the order or use of specific steps or actions may be modified without departing from the scope of the claims. Further, the various operations of methods described above may be performed by any suitable means capable of performing the corresponding functions. The means may include various hardware or software component(s) or module(s), including, but not limited to a circuit, an application specific integrated circuit (ASIC), or processor. Generally, where operations are illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later become known to those of ordinary skill in the art are expressly incorporated herein by reference and are intended to be encompassed by the claims. Moreover, nothing disclosed herein is intended to be dedicated to the public, regardless of whether such disclosure is explicitly recited in the claims.

What is claimed is:

1. A method of generating a workflow, comprising:
receiving a problem statement specified by a user in a natural language;
inferring a workflow template that maps to the problem statement by at least one machine learning model;
receiving a parameter of the workflow template from a template repository;
generating a value of the parameter of the workflow template by the at least one machine learning model based on the problem statement; and
populating the workflow template with the value.

2. The method of claim 1, further comprising:
receiving a score from the at least one machine learning model representing a confidence level of accuracy of the value;
comparing the score to a threshold; and
determining that the score satisfies the threshold.

3. The method of claim 2, further comprising triggering generation of the workflow with a workflow system based on the workflow template.

4. The method of claim 2, further comprising interacting with the user in the natural language to request and receive data associated with the workflow template by the at least one machine learning model.

5. The method of claim 1, further comprising
determining context data from the problem statement;
mapping the context data to a first set of one or more parameters;
determining a second set of one or more parameters associated with the workflow template; and
determining one or more missing parameters based on a comparison of the first set of one or more parameters and the second set of one or more parameters.

6. The method of claim 5, wherein determining the context data comprises determining at least one of a condition, trigger, or action.

7. The method of claim 5, wherein interacting with the user further comprises translating the one or more missing parameters into one or more natural language requests for data with the at least one machine learning model.

8. The method of claim 1, wherein one of the at least one machine learning model is a generative pre-trained transformer.

9. The method of claim 1, further comprising receiving the problem statement specified by the user through a conversational virtual agent linked with a software application including a workflow system.

10. The method of claim 9, wherein the software application is a financial management software application.

11. A system, comprising:
at least one processor; and
at least one memory coupled to the at least one processor that stores instructions, that when executed by the at least one processor, cause the system to:
receive a problem statement specified by a user in a natural language;
infer a workflow template that maps to the problem statement by at least one machine learning model;
receive a parameter of the workflow template from a template repository;
generate a value of the parameter of the workflow template by the at least one machine learning model based on the problem statement; and
populate the workflow template with the value.

12. The system of claim 11, wherein the instructions further cause the system to:
receive a score from the at least one machine learning model representing a confidence level of accuracy of the value generated;
compare the score to a threshold; and
determine that the score satisfies the threshold.

13. The system of claim 12, wherein the instructions further cause the system to trigger generation of the workflow with a workflow system based on the workflow template.

14. The system of claim 11, wherein the instructions further cause the system to:
determine context data from the problem statement;
map the context data to a first set of one or more parameters;
identify a second set of one or more parameters associated with the workflow template; and
determine one or more missing parameters based on a comparison of the first set of one or more parameters and the second set of one or more parameters.

15. The system of claim 14, wherein interacting with the user further comprises translating the one or more missing parameters into one or more natural language requests for data with the at least one machine learning model.

16. The system of claim 11, wherein one of the at least one matching learning model is a generative pre-trained transformer.

17. The system of claim 11, wherein the instructions further cause the system to receive the problem statement specified by the user through a conversational virtual agent linked with a software application including a workflow system.

18. The system of claim 17, wherein the software application is a financial management software application.

19. A method of workflow generation, comprising:
receiving a problem statement specified by a user in a natural language through a conversational virtual agent linked with a software application including a workflow system;
inferring a workflow template that maps to the problem statement by at least one machine learning model;
interacting with the user in the natural language through the conversational virtual agent to request and receive data associated with the workflow template by the at least one machine learning model;
populating the workflow template with the data by the at least one machine learning model; and
triggering generation of a workflow by the workflow system with the workflow template.

20. The method of claim 19, further comprising:
determining one or more missing parameters of the workflow template;
translating the one or more missing parameters into one or more natural language requests for the data with the at least one machine learning model;
sending the one or more natural language requests to the user with the conversational virtual agent as part of interacting with the user; and
updating the workflow template to include parameter values received in response to the one or more natural language requests.
